(19) United States
(12) Patent Application Publication
(10) Pub. No.: US 2015/0160894 A1
(43) Pub. Date: Jun. 11, 2015

(54) INFORMATION PROCESSING APPARATUS, RECORDING MEDIUM, AND CONTROL METHOD

(71) Applicant: CANON KABUSHIKI KAISHA, Tokyo (JP)

(72) Inventor: Shinya Suzuki, Kawasaki-shi (JP)

(21) Appl. No.: 14/563,859

(22) Filed: Dec. 8, 2014

(30) Foreign Application Priority Data
Dec. 10, 2013 (JP) 2013-255205

(51) Int. Cl. G06F 3/12

(52) U.S. Cl. CPC G06F 3/123; G06F 3/1232; G06F 3/1209

(57) ABSTRACT

An information processing apparatus acquires device information from a printer by bidirectional communication using a first protocol if it is determined that the device information is acquirable by bidirectional communication using the first protocol, and acquires the device information from the printer by bidirectional communication using a second protocol if it is determined that the device information is not acquirable by bidirectional communication using the first protocol. The information processing apparatus performs print processing using the acquired device information.

### BACKGROUND OF THE INVENTION

1. Field of the Invention

The present invention relates to a bidirectional communication technique.

2. Description of the Related Art

Japanese Patent Application Laid-Open No. 2008-152728 discusses a technique for performing print processing by using a plurality of filters.

When print processing is performed, a printer driver may need to acquire device information of a printer. Such acquisition of device information may be necessary depending on the printer. For example, “calibration data” unique to each output device is information necessary for page description language (PDL) conversion. The printer driver desirably acquires the “calibration data” every time print processing is performed. However, a printer driver discussed in Japanese Patent Application Laid-Open No. 2008-152728 may have difficulty in acquiring such device information by using bidirectional communication, depending on printer architecture.

Moreover, even if the printer driver is configured to acquire the device information with such printer architecture, device information acquirable by the printer driver may differ for each protocol. In particular, there is a possibility that although the printer driver cannot acquire device information from a printer using a first protocol (e.g., a standard protocol provided by printer architecture including a plurality of filters), the printer driver can acquire the device information from the printer using a second protocol. It is also conceivable that such a relation may be reversed in a printer having different firmware, for example.

### SUMMARY OF THE INVENTION

The present invention is directed to a system capable of performing print processing by using device information acquired from a printer by bidirectional communication using a first protocol or a second protocol to obtain a suitable output result.

According to an aspect of the present invention, an information processing apparatus, which is capable executing a printer driver including a plurality of filters, includes a determination unit configured to determine whether device information to be used by a succeeding filter is acquirable from a printer by bidirectional communication using a first protocol, an acquisition unit configured to acquire the device information from the printer by bidirectional communication using the first protocol if the determination unit determines that the device information is acquirable by bidirectional communication using the first protocol, and to acquire the device information from the printer by bidirectional communication using a second protocol if the determination unit determines that the device information is not acquirable by bidirectional communication using the first protocol, and a processing unit configured to perform print processing using the device information acquired by the acquisition unit.

Further features of the present invention will become apparent from the following description of exemplary embodiments with reference to the attached drawings.

### BRIEF DESCRIPTION OF THE DRAWINGS

FIG. 1 a block diagram illustrating a hardware and software configuration of a computer system.

FIG. 2 is a block diagram illustrating a configuration of a print processing system.

FIG. 3 is a flowchart illustrating print processing performed by a filter pipeline manager.

FIG. 4 is a flowchart illustrating processing performed by a communication filter according to a first exemplary embodiment.

FIG. 5 is a flowchart illustrating processing performed by a layout filter according to the first exemplary embodiment.

FIG. 6 is a flowchart illustrating processing performed by a renderer filter according to the first exemplary embodiment.

FIG. 7 is a flowchart illustrating processing performed by a communication filter according to a second exemplary embodiment.

FIG. 8 is a flowchart illustrating processing performed by a layout filter according to the second exemplary embodiment.

FIG. 9 is a flowchart illustrating processing performed by a renderer filter according to the second exemplary embodiment.

### DESCRIPTION OF THE EMBODIMENTS

Various exemplary embodiments, features, and aspects of the invention will be described in detail below with reference to the drawings.

A flow of printing using a version 3 (V3) printer driver of Microsoft (trademark) Windows (trademark) is described.

When files such as documents and diagrams created on a personal computer are printed from an application, the V3 printer driver is used to convert drawing data into PDL data and the resultant data is transmitted to a printer. The drawing data includes a print setting designated by a user using the V3 printer driver. The V3 printer driver may need device information retained by the printer of an output target to convert the drawing data into the PDL data. In such a case, the V3 printer driver acquires the device information by bidirectionally communicating with the output target printer.

The V3 printer driver includes mechanisms referred to as a port monitor and a language monitor to bidirectionally communicate with the printer. Each of the port monitor and the language monitor has a function of communicating with the printer.

The port monitor can control communication between a print manager that accesses the printer and the V3 printer driver. The V3 printer driver performs print processing through the port monitor. Moreover, the V3 printer driver may acquire the device information using a standard bidirectional communication function (e.g., bidirectional printer communication) available in an operating system (OS). Herein, the device information acquirable by the bidirectional communication is information acquired by a “web services for devices (WSD)” protocol. Typical port monitors provided by the OS include USBMon that supports a universal serial bus (USB) port, TCPMon that provides a standard transmission control protocol/Internet protocol (TCP/IP), and WSDMon that provides a WSD port.

The language monitor can acquire device information via the port monitor. Moreover, the language monitor can acquire device information that cannot be acquired by the port monitor by opening a port using unique bidirectional communication that uses a unique protocol different from the WSD protocol. A printer vendor can pack this language monitor with a V3 printer driver installation set, so that the language monitor can be supplied to a user.

On the other hand, a version 4 (V4) printer driver cannot utilize the language monitor. Thus, the unique bidirectional communication cannot be performed by the above language monitor. According to a configuration described below, even when the V4 printer driver (hereinafter simply referred to as a printer driver) is used, the printer driver is capable of utilizing the unique bidirectional communication.

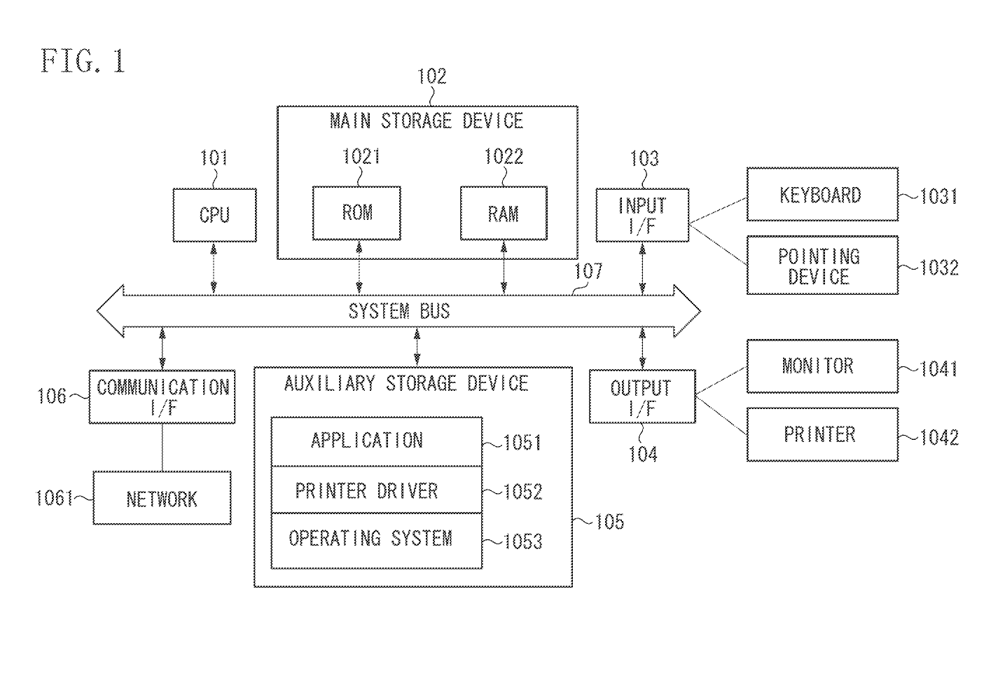

A first exemplary embodiment of the present invention is described below. FIG. 1 is a block diagram illustrating a hardware configuration of an information processing apparatus.

A central processing unit (CPU) 101 comprehensively controls an apparatus according to a program stored in a read only memory (ROM) 1021 or a random access memory (RAM) 1022 of a main storage device 102, or an auxiliary storage device 105. The RAM 1022 is also used as a work area when the CPU 101 performs various processing. The auxiliary storage device 105 stores, for example, an application 1051, a printer driver 1052, and an OS 1053. The printer driver 1052 can issue a print instruction to the printer. Input devices including a keyboard 1031 and a pointing device 1032 such as a mouse and a touch panel are used when a user provides various instructions to a computer through an input interface (I/F) 103. An output I/F 104 is an interface for outputting data to an external unit such as a monitor 1041 and a printer 1042. The printer 1042 may be directly connected to a local input output (I/O) unit. Alternatively, the printer 1042 may be connected to a network 1061 via a communication I/F 106. A common data system bus 107 exchanges data between these interfaces or modules.

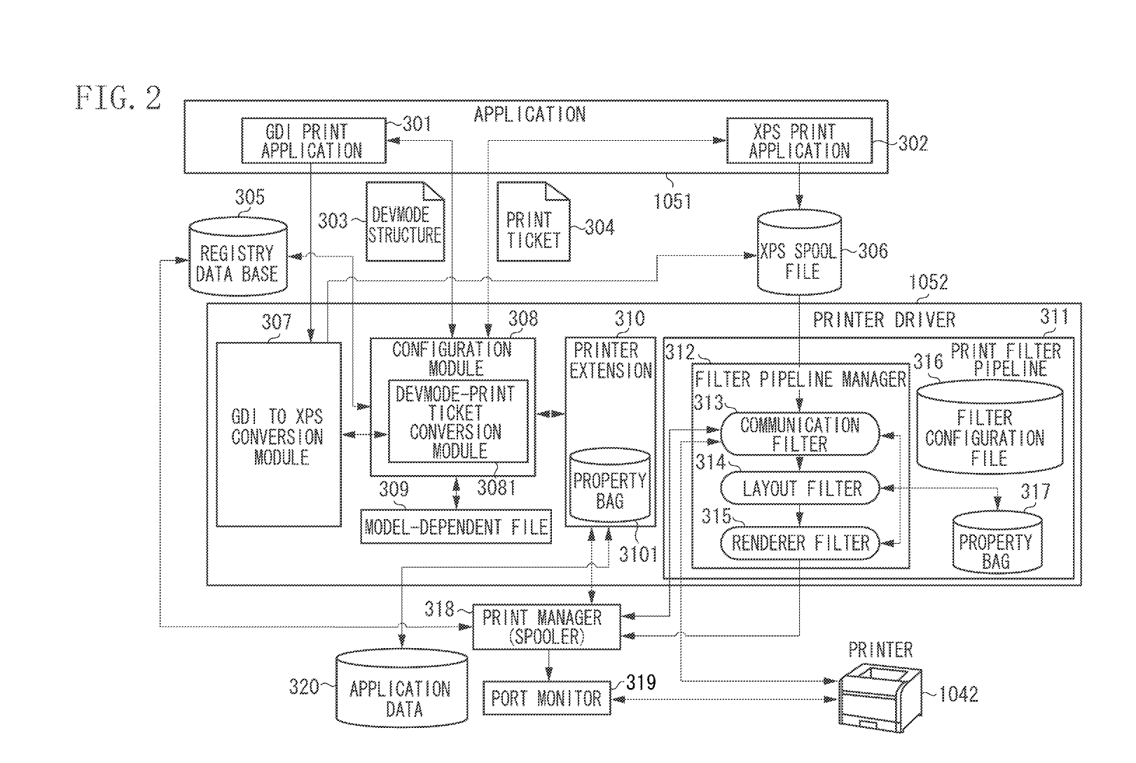

FIG. 2 is a block diagram illustrating an example configuration of a driver printing system that operates on the OS 1053. The driver printing system uses a file format referred to as an XML paper specification (hereinafter abbreviated to XPS) as spool data to perform printing. A print manger 318, a graphics device interface (GDI) to XPS conversion module 307, and a filter pipeline manager 312 are modules included in the OS 1053. Although the GDI to XPS conversion module 307 and the filter pipeline manager 312 are included in the printer driver 1052, each of the GDI to XPS conversion module 307 and the filter pipeline manager 312 is treated as a module of the printer driver 1052 provided by the OS 1053. The printer driver 1052 and each filter of the filter pipeline manager 312 are stored in the auxiliary storage device 105 as the printer driver 1052. A GDI print application 301 and an XPS print application 302 are stored in the auxiliary storage device 105 illustrated in FIG. 1 as the application 1051. The user uses the input device (e.g., the keyboard 1031 and the pointing device 1032) to issue a print instruction. That is, the user operates a user interface (UI) screen of the GDI print application (hereinafter referred to as a GDI application) 301 or the XPS print application (hereinafter referred to as an XPS application) 302 displayed on the monitor 1041, so that print processing is executed.

In the print processing, three operations of printer selection, print setting generation, and drawing data conversion are sequentially executed. First, the printer 1042 to be used is selected. From a user standpoint, the selection of the printer 1042 has substantially the same meaning as selection of the printer driver 1052 corresponding to the printer 1042 which executes printing. If the printer driver 1052 needs to be selected, print queue is used.

Next, print setting information is generated. In the print setting, first, the application 1051 secures a memory region used for print setting in the RAM 1022. The application 1051 invokes a configuration module 308 of the printer driver 1052 to generate print setting data, and stores the generated print setting data. The GDI application 301 uses a binary DEVMODE structure 303 as print setting data. The XPS application 302 uses a print ticket 304 described in an extensible markup language (XML). The DEVMODE structure 303 includes a standard area defined by the OS 1053, and an expanded area uniquely defined by the printer driver 1052.

The print ticket 304 includes the print setting data described in the XML format, and a standard area and an expanded area are separately described according to namespace. Since the print setting data includes information unique to a model, the configuration module 308 uses a model-dependent file 309 to generate the print setting data. The DEVMODE structure 303 or the print ticket 304 retains the print setting data, so that the application 1051 directly rewrite a value of the print setting data to change the print setting. Moreover, a setting that is dedicated to and dependent on the printer 1042 is set by using a user interface of a printer extension 310. Although the printer extension 310 is one type of the printer driver 1052, the printer extension 310 is installed as another application. The printer extension 310 includes a data storage area referred to as a property bag 3101 that can be accessed from the printer extension 310, the configuration module 308, and each filter of the filter pipeline manager 312.

The printer driver 1052 changes printer-dependent setting data of the DEVMODE structure 303 or the print ticket 304 according to a setting of the user interface. The printer-dependent setting is dependent on the printer 1042. More specifically, the print setting data represents data required when printing is performed, for example, “A4” indicating size of a sheet to be output, and “landscape” indicating an orientation of printing. Since the print ticket 304 contains the print setting data described in the XML format, the XPS application 302 can readily and directly rewrite and change all of setting values. However, the user interface of the printer extension 310 may be used to change the setting. The print setting data is generated every time document printing is performed. When the user intends to store data of an optional device of the printer 1042 or an environment setting for each user, such data is stored in a registry data base 305 of the OS 1053 through the user interface. In a case where the registry data base 305 cannot be used, the setting information is stored as application data 320 through the user interface. The print manger 318 of the OS 1053 stores a default value of the print setting in the registry data base 305. The registry data base 305 and the application data 320 are stored in the auxiliary storage device 105.

Lastly, the drawing data conversion is executed. When the print setting is determined, the user carries out the print processing from the application 1051. If printing is performed according to the GDI application 301, the drawing data is transmitted to the GDI to XPS conversion module 307 having a printer driver format, so that an XPS spool file 306 is generated. At that time, the GDI to XPS conversion module 307 invokes the configuration module 308 to convert the print setting data from the DEVMODE structure 303 into the print ticket 304. In such conversion, a DEVMODE-print ticket conversion module 3081 is used. If printing is performed according to the XPS application 302, there are two methods for generating an XPS file. According to one method, the XPS application 302 generates an XPS file. According to the other method, the OS 1053 generates an XPS file according to a drawing command from the XPS application 302. With either of these methods, the XPS spool file 306 is generated in the course of printing.

After the XPS spool file 306 is generated, a print filter pipeline 311 performs subsequent processing. The print filter pipeline 311 has a structure in which data is processed by passing it through a plurality of filters, meanwhile the number of filters and their sequence are controlled by a filter configuration file 316. The filter pipeline manager 312, which operates on the print filter pipeline 311, executes processing according to the filter configuration file 316. In the present exemplary embodiment, the processing is performed by a communication filter 313, a layout filter 314, and a renderer filter 315 in this order. The number of filters and a filter type differ depending on a configuration of the printer driver 1052. When the print processing is performed, the XPS spool file 306 is sequentially transferred to the filters 313, 314, and 315. Each of these filters 313, 314, and 315 processes the XPS spool file 306, and transfers the processed XPS spool file 306 to a next filter. Thus, the print processing can be carried out. Lastly, the XPS spool file 306 is output as data described in a printer control language (e.g., PDL) serving as a data language comprehensible by a printer. The XPS spool file 306 may be printed without all the processing in the filters 313, 314, and 315 if the printer 1042 is an XPS direct printer capable of directly reading and printing the XPS spool file 306. Each of the filters 313, 314, and 315 can store the data in a property bag 317. Moreover, information of the OS 1053 and data of the other filters can be obtained from property bag 317.

In the communication filter 313, the print ticket 304 is read and data necessary to perform printing is written in the print ticket 304. The layout filter 314 performs layout related processing. For example, the layout filter 314 changes magnification, and lays out bookbinding imposition and stamp. The renderer filter 315 of the last filter renders and converts the XPS spool file 306 into PDL data. The PDL data is managed by the print manager 318 which manages print processing schedule, and print jobs are successively registered in a queue (a waiting line). When the printer 1042 becomes ready for printing, the PDL data is transmitted to the printer 1042 through a port monitor 319 in queue registration order.

Accordingly, the printer driver 1052, as a main function, converts the print data provided from the application into the PDL data, so that the above print processing is performed.

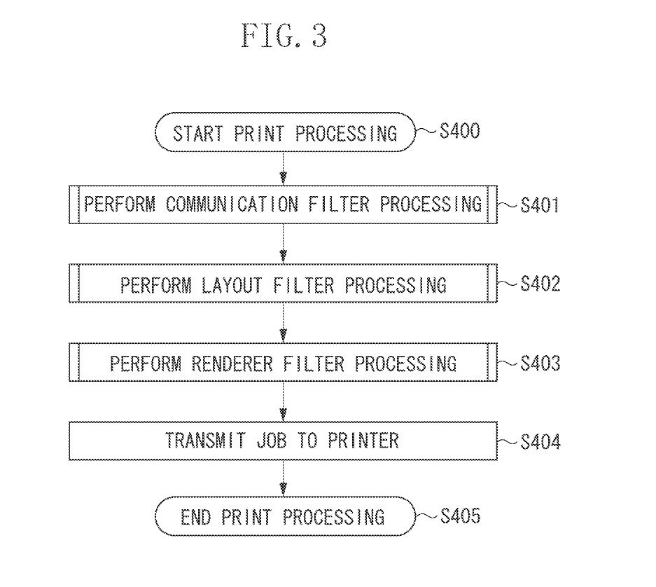

Hereinafter, the present exemplary embodiment of the present invention is described with reference to flowcharts illustrated FIGS. 3, 4, 5, and 6.

FIG. 3 is a flowchart illustrating one example of the print processing executed by the filter pipeline manager 312 which operates on the print filter pipeline 311 of the OS when printing is performed. A printer vender provides a filter that is to be executed by the filter pipeline manager 312, so that the filter pipeline manager 312 can have a rendering function of changing a layout or converting data into PDL data according to a print setting set by the user.

In step S400, when the user executes printing from the application 1051, the OS 1053 executes the filter pipeline manager 312 and print processing is started.

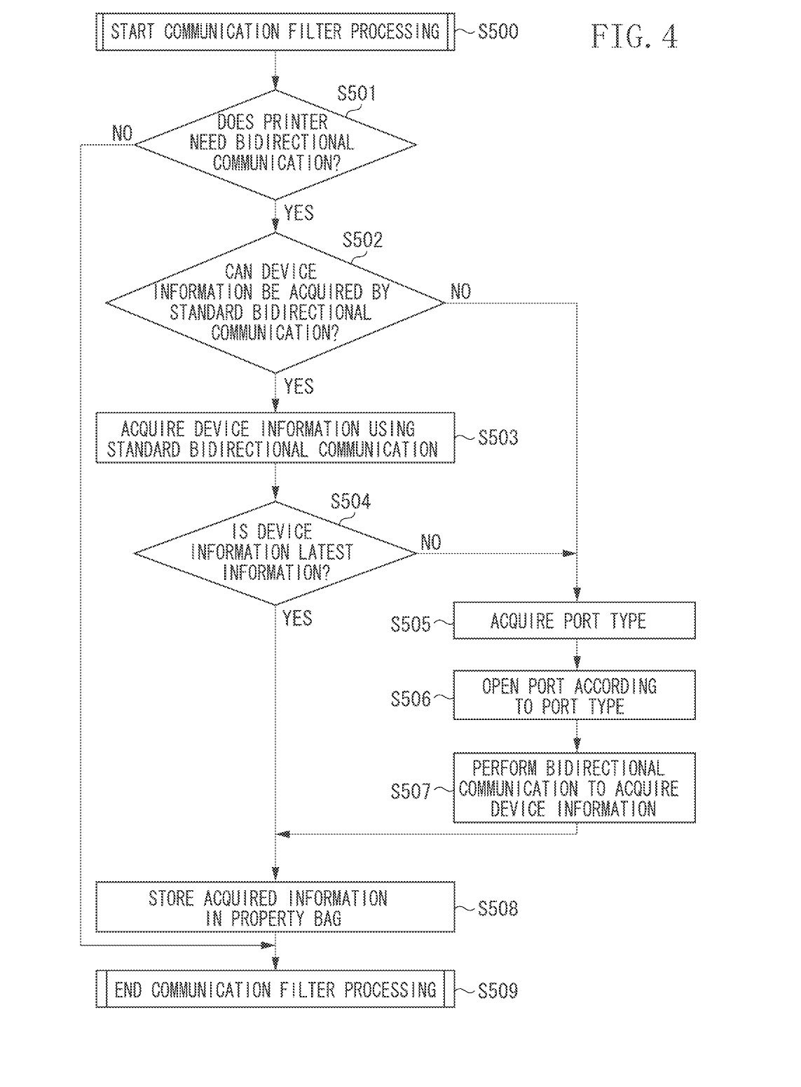

In step S401, the communication filter 313 performs communication filter processing. This processing in step S401 is described with reference to a flowchart illustrated in FIG. 4.

FIG. 4 is a flowchart illustrating one example of the communication filter processing. With the processing illustrated in FIG. 4, the communication filter 313 determines whether device information to be used by the succeeding filters (the layout filter 314 and the renderer filter 315) can be acquired by standard bidirectional communication. If the device information cannot be acquired, or if the acquired device information is not latest information, the processing in FIG. 4 acquires device information acquirable by unique bidirectional communication. Such processing is described below.

In step S500, the communication filter 313 starts the processing.

In step S501, the communication filter 313 determines whether an output target printer needs bidirectional communication.

When printing is performed, the output target printer may not need device information depending on an output format to be used in the printing. For example, if raster printing is performed, the renderer filter 315 can adjust drawing data according to a color shift adjustment value of the printer in the print processing. On the other hand, if vector printing is performed, an adjustment of the drawing data is not necessary in the print processing, and thus, the device information is not necessary. Accordingly, information indicating whether the printer driver 1052 performs the print processing using the raster printing or the vector printing is described beforehand in the model-dependent file 309. That is, information indicating whether bidirectional communication is needed is described beforehand in the model-dependent file 309. This enables the communication filter 313 to determine whether the output target printer needs the bidirectional communication based on the model-dependent file 309.

Alternatively, the communication filter 313 may at the start uniquely-bidirectionally communicate with a printer. If the unique bidirectional communication fails, the communication filter 313 may determine that the printer does not need the bidirectional communication. In particular, the communication filter 313 makes any request to the printer, and determines whether the printer can respond to the request. For example, the communication filter 313 requests the printer to check whether bidirectional communication is feasible. If the communication filter 313 receives a response indicating that the bidirectional communication is feasible from the printer within a predetermined time period, the communication filter 313 can determine that the printer needs the bidirectional communication (YES in step S501).

If the communication filter 313 determines that the target printer does not need the bidirectional communication (NO in step S501), the operation proceeds to step S509 in which the communication filter processing ends. If the printer needs the bidirectional communication (YES in step S501), the operation proceeds to step S502.

In step S502, the communication filter 313 determines whether device information to be used by the succeeding filters can be acquired by using standard bidirectional communication. The standard bidirectional communication is a bidirectional communication method that uses the port monitor 319 provided by the OS 1053. For example, the standard bidirectional communication can be performed by using bidirectional printer communication (also referred to as bidi printer communication) to communicate with the printer. The communication filter 313 actually tries to acquire device information by using the standard bidirectional communication to determine whether the standard bidirectional communication can be used. If the communication filter 313 can acquire the device information (YES in step S502), the operation proceeds to step S503.

In step S503, the communication filter 313 acquires the device information by using the standard bidirectional communication.

Subsequently, in step S504, the communication filter 313 determines whether the device information acquired by using the standard bidirectional communication is the latest information. There is a possibility that the port monitor 319 may have cache information depending on a connection port. For example, a WSD port may retain cache information and standard bidirectional communication may cause the WSD port to return the cache information as device information. In such a case, the device information may not be the latest information. Hence, the communication filter 313 acquires timestamp information from the device information, and calculates a difference between a date and time of the time stamp and a current date and time. If the difference is within a predetermined time period, the communication filter 313 determines that the device information is the latest information. For example, a predetermined time period is 24 hours. In such a case, if a date and time of the time stamp is Nov. 28, 2013 at 14:00, and a current date and time is Nov. 29, 2013 at 13:00, the device information is determined as the latest information.

Moreover, in a TCP/IP port, cache information is not retained, and thus the acquired device information is the latest information. Accordingly, if the TCP/IP connection is used, the acquired information may be determined as the latest information.

If the communication filter 313 determines that the device information is the latest information (YES in step S504), the operation proceeds to step S508.

If the communication filter 313 determines that the device information cannot be acquired by using the standard bidirectional communication (NO in step S502), or the device information is not the latest information (NO in step S504), the operation proceeds to step S505.

In step S505, the communication filter 313 acquires a port type of a connection port being currently set. Then, the operation proceeds to step S506.

In step S506, the communication filter 313 opens the port according to the port type acquired in step S505.

Subsequently, in step S507, the communication filter 313 performs bidirectional communication using a unique protocol to acquire device information. Then, the operation proceeds to step S508.

In step S508, the communication filter 313 stores the acquired device information in the property bag 317. The succeeding filters access this device information stored in the property bag 317. Then, in step S509, the communication filter processing ends.

The filter pipeline manager 312 automatically finishes the processing when a certain time period elapses from the completion of printing. In such a case, the information stored in the property bag 317 is cleared. Thus, the acquired device information may be stored as a file in a place other than the property bag 317. In such a case, the succeeding filters use the stored file to acquire the device information.

According to the present exemplary embodiment, the communication filter 313 determines whether the device information can be acquired by using the standard bidirectional communication in step S502, and determines whether the device information is the latest information in step S504. Alternatively, such determination may be made by each of the succeeding filters. In such a case, the communication filter 313 always performs communication using a unique protocol, and stores acquired device information in the property bag 317. Accordingly, the succeeding filters determine whether to perform standard bidirectional communication, and whether to use the device information of the property bag 317.

In addition, in a case where device information has a plurality of items, the processing from steps S501 to S508 may be performed for each item. In such a case, the processing from steps S501 to S508 needs to be repeatedly performed until all of the plurality of items are processed.

Accordingly, the communication filter processing of step S401 illustrated in FIG. 3 is finished, and the operation proceeds to step S402.

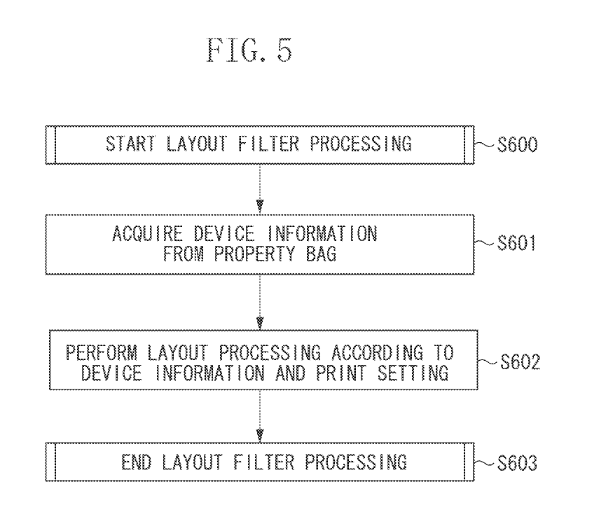

In step S402, the layout filter 314 performs processing that is described with reference to a flowchart illustrated in FIG. 5.

FIG. 5 is a flowchart illustrating one example of the processing performed by the layout filter 314. The layout filter 314 performs layout processing that is one of the print processing.

In step S600, the layout filter 314 starts the processing.

In step S601, the layout filter 314 acquires the device information from the property bag 317.

Subsequently, in step S602, the layout filter 314 performs the layout processing according to the device information and a print setting. Particularly, the layout filter 314 determines whether the acquired information indicates that “the printer has a storage area such as a hard disk”, then may change the layout processing depending on the presence or absence of a storage area in the printer. If a print setting includes “2 copies” as the number of copies and “sort printing” while the acquired information indicates the presence of a storage area in the printer, the layout filter 314 does not perform duplication processing described below. If the storage area of the printer is used, “2 copies” are made and “sort printing” can be performed. On the other hand, if the layout filter 314 determines that the device information indicates the absence of a storage area, the layout filter 314 executes the duplication processing that generates a duplicate of a print job. The layout filter 314 transmits the two print jobs, so that “2 copies” and “sort printing” are achieved. Accordingly, the layout processing is performed using the print setting and the device information, and the operation proceeds to step S603.

In step S603, the processing performed by the layout filter 314 ends.

Consequently, the layout filter processing in step S402 illustrated in FIG. 4 ends, and the operation proceeds to step S403.

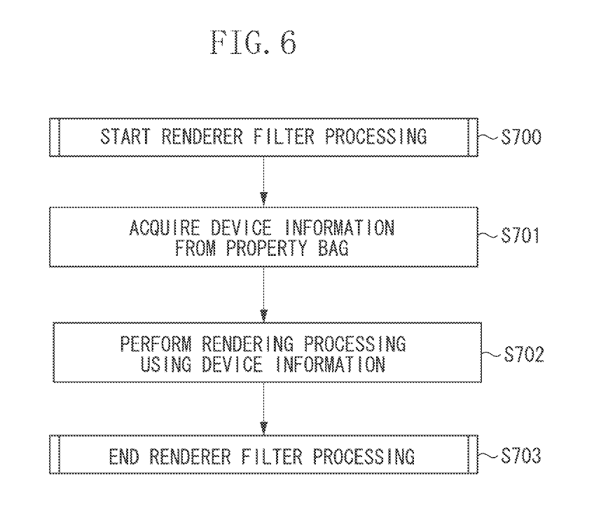

In step S403, the renderer filter 315 performs processing which is described with reference to a flowchart illustrated in FIG. 6.

FIG. 6 is a flowchart illustrating one example of the processing performed by the renderer filter 315. The renderer filter 315 performs rendering processing that is one of the print processing.

In step S700, the renderer filter 315 starts the processing. In step S701, the renderer filter 315 acquires the device information from the property bag 317. In step S702, the renderer filter 315 performs the rendering processing according to the device information. Specifically, color shift adjustment information is acquired as the device information. The renderer filter 315 can make a rendering adjustment by using the shift adjustment information. Thus, the renderer filter 315 performs the rendering processing by using the acquired device information. Subsequently, in step S703, the processing performed by the renderer filter 315 ends.

Consequently, the renderer filter processing of step S403 illustrated in FIG. 4 ends, and the operation proceeds to step S404.

In step S404, the filter pipeline manager 312 transmits the print job to the printer 1042 via the port monitor 319. Subsequently, in step S405, the print processing ends.

According to such processing, the communication filter 313 can bidirectionally communicate with the printer 1042 in an appropriate manner even in a new OS environment in which a language monitor cannot be installed, thereby obtaining an appropriate output result.

Moreover, such processing enables the communication filter 313 to bidirectionally communicate even with a printer model such as a legacy printer in an appropriate manner, thereby obtaining an appropriate output result. The legacy printer does not support standard bidirectional communication, although the legacy printer supports bidirectional communication using a unique protocol.

In the first exemplary embodiment, the communication filter 313 bidirectionally communicates with the printer 1042. However, in a case where a network connection consumes time, print processing may be directly affected. Particularly, if the layout filter 314 does not use device information, the layout processing and the bidirectional communication processing should be performed at the same time to enhance efficiency. In a second exemplary embodiment, asynchronous communication is used, so that operation of the print processing is not affected.

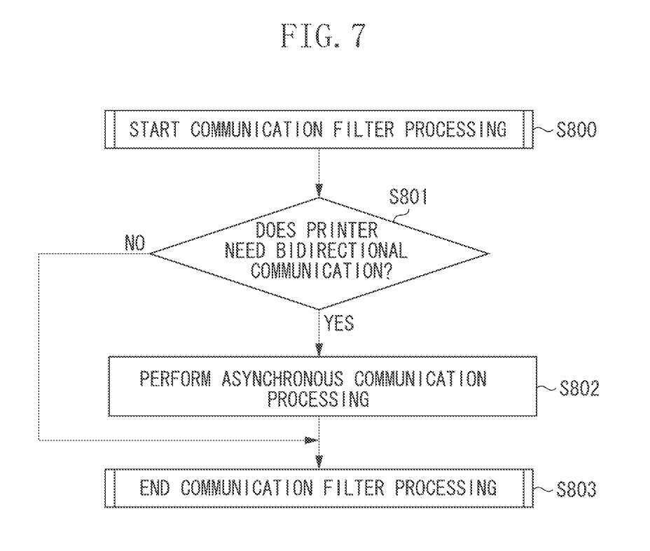

Hereinafter, the present exemplary embodiment of the present invention is described with reference to flowcharts illustrated in FIGS. 7 through 10.

A filter pipeline manager 312 operates on a print filter pipeline 311 of an OS when printing is performed. Since print processing executed by the filter pipeline manager 312 is similar to that described in the first exemplary embodiment, the description thereof is omitted. In the present exemplary embodiment, processing of each filter is described.

FIG. 7 is a flowchart illustrating one example of processing performed by a communication filter 313 when asynchronous communication processing is used. In step S800, the communication filter 313 starts the processing.

Since processing in step S801 is similar to that in step S501 illustrated in FIG. 4, the description thereof is omitted. If the communication filter 313 determines that a printer needs bidirectional communication (YES in step S801), then in step S802, the communication filter 313 performs asynchronous communication processing. Herein, the asynchronous communication processing represents processing in which communication processing is performed with a thread different from processing performed at the time of printing, and the print processing and the communication processing are concurrently performed. Actual processing in the asynchronous communication processing is substantially the same as that from step S502 to S508 illustrated in FIG. 4, and thus the description thereof is omitted. However, since the communication processing is concurrently performed with the print processing, the operation proceeds to step S803 upon completion of the processing in step S802 regardless of communication success or failure.

In step S803, the communication filter processing excluding the asynchronous communication processing ends.

Then, the operation proceeds to processing to be performed by a layout filter 314.

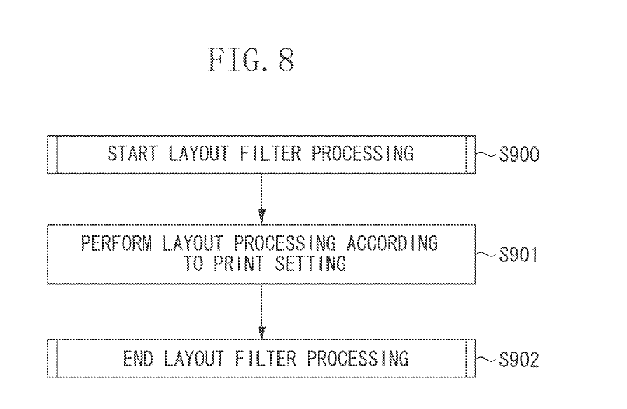

FIG. 8 is a flowchart illustrating one example of the processing performed by the layout filter 314 when asynchronous communication processing is performed. In the present exemplary embodiment, device information is not used when the layout filter 314 performs the processing.

In step S900, the layout filter 314 starts the processing. In step S901, the layout filter 314 performs layout processing according to a print setting. Subsequently, in step S902, the layout filter processing ends. In the present exemplary embodiment, the device information is not used as described above. Thus, even if the asynchronous communication processing is executed while the processing is being performed by the layout filter 314, the print processing is not affected. Then, the operation proceeds to processing to be performed by a renderer filter 315.

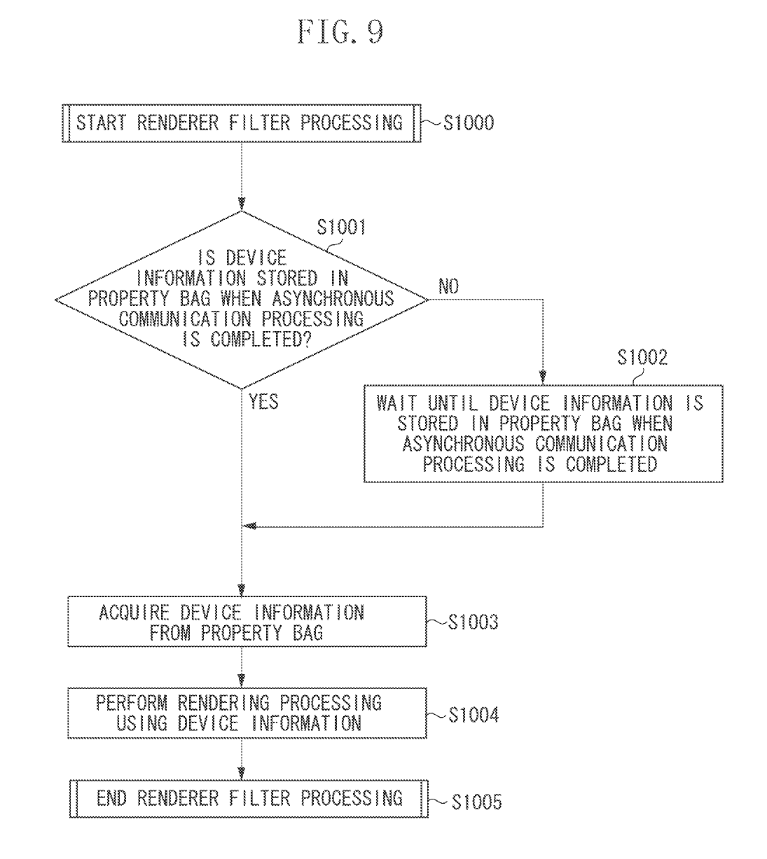

The renderer filter 315 starts the processing. FIG. 9 is a flowchart illustrating one example of the processing performed by the renderer filter 315 when the asynchronous communication processing is performed.

In step S1000, the renderer filter 315 starts the processing. In step S1001, the renderer filter 315 determines whether the asynchronous communication processing performed by the communication filter 313 in step S802 illustrated in FIG. 7 is finished. Herein, the renderer filter 315 determines whether device information is stored in a property bag 317. The property bag 317 has information indicating whether the asynchronous communication processing is completed as a flag. Alternatively, the renderer filter 315 determines whether the asynchronous communication processing is completed based on the flag in the property bag 317.

If the renderer filter 315 determines that the device information is not stored (NO in step S1001), the operation proceeds to step S1002. In step S1002, the renderer filter 315 waits until the asynchronous communication processing of the communication filter 313 is finished and the device information is stored in the property bag 317. If the asynchronous communication processing is completed (YES in step S1001), or if the device information is stored upon completion of the asynchronous communication processing (YES in step S1002), the operation proceeds to step S1003. Since the processing from step S1003 to step S1005 is substantially the same as that from S701 to S703 illustrated in FIG. 6, the description thereof is omitted.

Accordingly, even if communication processing consumes time, the asynchronous communication processing can minimize an adverse effect on the print processing while the communication filter 313 can bidirectionally communicate with the printer, thereby obtaining an appropriate output result. Moreover, in the present exemplary embodiment, the device information is not necessary in the processing performed by the layout filter 314. However, if the layout filter 314 needs the device information, the layout filter 314 may perform processing similar to that performed by the renderer filter 315 in the present exemplary embodiment.

According to the present invention, the print processing is performed by using the device information acquired from the printer by the bidirectional communication which uses a first protocol or a second protocol, so that a suitable output result is obtain.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-255205 filed Dec. 10, 2013, which is hereby incorporated by reference herein in its entirety.

What is claimed is:

1. An information processing apparatus capable of executing a printer driver including a plurality of filters, the information processing apparatus comprising:
a determination unit configured to determine whether device information to be used by a succeeding filter is acquirable from a printer by bidirectional communication using a first protocol;
an acquisition unit configured to acquire the device information from the printer by bidirectional communication using the first protocol if the determination unit determines that the device information is acquirable by bidirectional communication using the first protocol, and to acquire the device information from the printer by bidirectional communication using a second protocol if the determination unit determines that the device information is not acquirable by bidirectional communication using the first protocol; and
a processing unit configured to perform print processing using the device information acquired by the acquisition unit.

2. The information processing apparatus according to claim 1, further comprising a storage unit configured to store the device information acquired by the acquisition unit in a data storage area accessible by the plurality of filters.

3. The information processing apparatus according to claim 1, further comprising a second determination unit configured to determine whether the device information acquired by bidirectional communication using the first protocol has been acquired within a predetermined time period based on a time stamp of the device information acquired by bidirectional communication using the first protocol,
wherein, if the second determination unit determines that the device information has not been acquired within the predetermined time period, the acquisition unit further acquires the device information from the printer by bidirectional communication using the second protocol.

4. The information processing apparatus according to claim 1, wherein the acquisition unit acquires the device information by asynchronous communication, and
wherein the processing unit waits until the acquisition of the device information by the asynchronous communication is completed, and performs print processing using the completed device information.

5. The information processing apparatus according to claim 1, wherein the bidirectional communication using the first protocol is communication using bidirectional printer communication.

6. A control method for an information processing apparatus capable of executing a printer driver including a plurality of filters, the control method comprising:
determining whether device information to be used by a succeeding filter is acquirable from a printer by bidirectional communication using a first protocol;
acquiring the device information from the printer by bidirectional communication using the first protocol if it is determined that the device information is acquirable by bidirectional communication using the first protocol, and acquiring the device information from the printer by bidirectional communication using a second protocol if it is determined that the device information is not acquirable by bidirectional communication using the first protocol; and
performing print processing using the acquired device information.

7. The control method according to claim 6, further comprising storing the acquired device information in a data storage area accessible by the plurality of filters.

8. The control method according to claim 6, further comprising determining whether the device information acquired by bidirectional communication using the first protocol has been acquired within a predetermined time period based on a time stamp of the acquired device information acquired by bidirectional communication using the first protocol,
wherein, if it is determined that the device information has not been acquired within the predetermined time period, the device information is acquired from the printer by bidirectional communication using the second protocol.

9. The control method according to claim 6, wherein the device information is acquired by asynchronous communication, and
wherein the processing waits until acquisition of the device information by the asynchronous communication is completed, and performs print processing using the completed device information.

10. The control method according to claim 6, wherein the bidirectional communication using the first protocol is communication using bidirectional printer communication.

11. A non-transitory recording medium storing a program for causing a computer capable of executing a printer driver including a plurality of filters to perform operations comprising:
determining whether device information to be used by a succeeding filter is acquirable from a printer by bidirectional communication using a first protocol;
acquiring the device information from the printer by the bidirectional communication using the first protocol if the determining determines that the device information is acquirable by bidirectional communication using the first protocol, and acquiring the device information from the printer by bidirectional communication using a second protocol if the determining determines that the device information is not acquirable by the bidirectional communication using the first protocol; and
performing print processing using the acquired device information.
